(19) United States
(12) Patent Application Publication
(10) Pub. No.: US 2012/0281036 A1
(43) Pub. Date: Nov. 8, 2012

(54) LIQUID EJECTING APPARATUS

(75) Inventors: Masaru KOBASHI, Matsumoto (JP); Yoichi YAMADA, Shiojiri (JP); Toshiya OKADA, Chino (JP)

(73) Assignee: SEIKO EPSON CORPORATION, Tokyo (JP)

(21) Appl. No.: 13/461,156

(22) Filed: May 1, 2012

(30) Foreign Application Priority Data
May 6, 2011 (JP) 2011-103654

(51) Int. Cl. B41J 29/38

(52) U.S. Cl. 347/10

(57) ABSTRACT

A liquid ejecting apparatus includes a liquid ejecting head that includes a nozzle formation face on which a nozzle that ejects a liquid is formed and a pressure generator that is driven by the application of a driving signal for causing a pressure fluctuation in the liquid within a pressure chamber that is connected to the nozzle, and that ejects the liquid from the nozzle to a landing target by the driving of the pressure generator, a voltage application unit that is placed at a position that does not interfere with the liquid ejecting head, on the opposite side to the landing target with respect to the nozzle formation face, and at a position outside a region that opposes the nozzle formation face, and a voltage application section that applies a voltage to the voltage application unit.

### CROSS REFERENCES TO RELATED APPLICATIONS

The present invention contains subject matter related to Japanese Patent Application No. 2011-103654 filed in the Japanese Patent Office on May 6, 2011, the entire contents of which are incorporated herein by reference.

### BACKGROUND

1. Technical Field

The present invention relates to a liquid ejecting apparatus such as an ink jet recording apparatus, and particularly relates to a liquid ejecting apparatus that ejects a liquid within a pressure chamber from nozzles by the driving of a pressure generator.

2. Related Art

A liquid ejecting apparatus is an apparatus that includes a liquid ejecting head and that ejects various liquids from the ejecting head. While as such a liquid ejecting apparatus, there is, for example, an image recording apparatus such as an ink jet printer or an ink jet plotter, recently, liquid ejecting apparatuses have also been applied to various manufacturing apparatuses taking advantage of the feature that it is possible for a very small amount of liquid to be made to land accurately at predetermined positions. For example, liquid ejecting apparatuses have been applied to display manufacturing apparatuses that manufacture color filters of liquid crystal displays or the like, electrode forming apparatuses that form electrodes of organic EL (Electro Luminescence) displays and FEDs (Field Emission Displays) or the like, and chip manufacturing apparatuses that manufacture biochips (biochemical elements). Furthermore, liquid ink is ejected with a recording head for an image recording apparatus, and solutions of each color material of R (Red), G (Green), and B (Blue) are ejected with a color material ejecting head for a display manufacturing apparatus. Further, a liquid electrode material is ejected with an electrode material ejecting head for an electrode forming apparatus, and a bioorganic solution is ejected with a bioorganic ejecting head for a chip manufacturing apparatus.

With the recording head described above that is used in a printer or the like, in recent years, there has been a trend of decreasing the fluid volume of the ink that is ejected from the nozzles in order to meet demands such as an improvement in the image. In order for such minute amounts of droplets to be made to land reliably on a recording medium, the initial velocity of the droplets is set relatively high. In so doing, the droplets that are ejected from the nozzles are stretched in midflight and separate into a leading main droplet and later satellite droplets (sub droplets). A portion or the entirety of such satellite droplets may rapidly decrease in speed due to the viscous drag of the air, and may become a mist without reaching the recording medium. As a result, there was a problem that the satellite droplets (mist) that had become a mist contaminate the inside of the apparatus, causing an operation failure by adhering to members that are easily charged such as the recording head or an electrical circuit.

In order to prevent such an inconvenience, there have been attempts to cause mist to land reliably on an absorption member by charging the droplets that are ejected from the nozzles and forming an electric field between the absorption member that absorbs the droplets which is provided on a support member (or a platen) that supports the recording medium during recording and the nozzle formation face of the recording head (for example, refer to JPA-2010-173324).

However, as illustrated in the schematic diagram of FIG. 9A, in the process of the ink that is ejected from a nozzle 64 of the recording head spreading toward a recording medium P and a support member 65, while a negative charge is inducted to the leading portion (portion that becomes a main droplet Md) on the side near the support member 65 through electrostatic induction from the positively charged support member 65, a positive charge is inducted on the end portion on the side near the nozzle 64 on the opposite side. Furthermore, as illustrated in FIG. 9B, in a case when the ink that is ejected from the nozzle separates into the main droplet Md, a first satellite droplet Sd1, and a second satellite droplet (mist) Sd2, for example, the main droplet Md is negatively charged, the second satellite droplet Sd2 is positively charged, and the first satellite droplet Sd1 is uncharged. In such a case, even if the main droplet Md and the first satellite droplet Sd1 land on the recording medium P, the second satellite droplet Sd2 is repelled by the positively charged support member 65 and drifts as mist in the vicinity of the nozzle formation face of the recording medium. A portion of the mist adheres to the nozzle formation face. In a case when mist adheres to the nozzle formation face, a need arises to periodically wipe the nozzle formation face using a wiping member. Further, there is a concern that the mist that does not adhere to the nozzle formation face adheres to and contaminates the constituent parts of the printer with a different polarity to the mist.

In view of the above, a configuration has also been proposed in which ink is ejected from a nozzle in a state in which the support member (base material) is negatively charged, for example, the polarity of the support member is switched to positive at the timing when the ink separates into the main droplet and the satellite droplets, and while the main droplet lands on the recording medium due to inertial force, the satellite droplets or mist lands on the recording medium by being drawn to the support member that is charged to have the opposite polarity to the satellite droplets or mist (for example, refer to JP-A-2010-214880).

However, in recent years, such types of printers have had a tendency of increasing driving frequency for ejecting ink, causing cases in which the next ink is ejected from a nozzle before the satellite droplets land on the recording medium. Therefore, with a configuration of switching the polarities of the electrodes at the timing of the ejecting of the ink or at the timing of the ink separating as described above, it became difficult for the satellite droplets to be made to reliably land on the recording medium, and as the flight of the main droplet is affected, there was a possibility that the landing would become unstable.

Further, while a configuration in which an electric field is not formed between the nozzle formation face and the support member in order to prevent charging of the ink is also considered, it is recognized that the ejected ink is still charged even in a case when ink is ejected from a nozzle with such a configuration. That is, for example, as illustrated in FIG. 10, with a configuration in which pressure fluctuation is caused within a pressure chamber 70 and ink is ejected to the recording medium P from a nozzle 71 using the pressure fluctuation by applying a driving voltage to a driving electrode 69 of a piezoelectric vibrator 68 of the recording head, when a positive voltage is input to the driving electrode 69 of the piezoelectric vibrator 68, since the piezoelectric vibrator 68 and the pressure chamber 70 are insulated, a negative charge is inducted on the ink within the pressure chamber 70 in the vicinity of the piezoelectric vibrator 68 due to electrostatic induction. Further, a positive charge is inducted on the ink in the vicinity of the nozzle 71 on the opposite side. Since a nozzle formation face 72 is grounded on a typical recording head, the positive charge of the ink moves to the nozzle formation face 72 side, as described above, with a configuration of ejecting ink with a higher driving frequency, ink is ejected from the nozzle 71 in a state in which the positive charge is remaining. As a result, the ink that is ejected from the nozzle 71 is positively charged.

Furthermore, the positive charge of the ink that is ejected from the nozzle 71 tends to strengthen (the negative weakens in a case when ejected in a negatively charged state) during the flight of the ink toward the recording medium P due to the Lenard effect. That is, in a case when the ink is charged, while a positive charge is collected at the center portion of the droplet, a negative charge is collected on the surface layer portion. Furthermore, the droplets gradually become biased toward a positively charged state due to the evaporation or splitting of the surface portion during flight.

In such a manner, since the ink that is ejected from the nozzle is charged even with a configuration in which an electric field is not formed between the nozzle formation face and the support member, there was an inconvenience that the mist would adhere to the nozzle formation face or the constituent parts of the printer.

Such a phenomenon is not limited to piezoelectric vibrators, and occurs similarly for other pressure generators such as heating elements that are operated by the application of a driving voltage.

### SUMMARY

An advantage of some aspects of the invention is that a liquid ejecting apparatus with which the liquid that is ejected from nozzles can be made to land on a predetermined member and the liquid is prevented from adhering to other members within the apparatus is provided.

According to an aspect of the invention, there is provided a liquid ejecting apparatus including: a liquid ejecting head that includes a nozzle formation face on which nozzles that eject a liquid are formed and a pressure generator that is driven by the application of a driving signal for causing a pressure fluctuation in the liquid within a pressure chamber that is connected to the nozzles, and that ejects the liquid from the nozzles to a landing target by a driving of the pressure generator; a voltage application unit that is placed at a position that does not interfere with the liquid ejecting head, on the opposite side to the landing target with respect to the nozzle formation face, and at a position outside a region that opposes the nozzle formation face; and a voltage application section that applies a voltage to the voltage application unit.

According to the invention, an electric field is formed between the voltage application unit and the liquid ejecting head by applying a voltage to the voltage application unit, and mist can be collected at one of the voltage application unit and the liquid ejecting head. In so doing, adherence of such mist on other constituent parts within the apparatus (for example, a motor, a driving belt, a linear scale, and the like) is decreased. As a result, breakdowns due to the adherence of mist are suppressed, and the durability and reliability of the liquid ejecting apparatus improves. Further, since the voltage application unit is placed on the opposite side to the landing target with respect to the nozzle formation face and at a position outside a region that opposes the nozzle formation face, the generation of an electric field (wraparound electric field) between the voltage application unit and the nozzle formation face can be prevented, and the flight of the liquid (main droplet) becoming unstable due to the influence of the electric field can be prevented.

According to the above configuration, it is preferable that the voltage application section apply a voltage with the opposite polarity to the polarity of the driving signal to the voltage application unit.

According to such a configuration, when the pressure generator is driven, the liquid in the vicinity of the nozzles is charged by electrostatic induction due to the voltage that is applied to the pressure generator, and in so doing, it is possible to collect the mist at the voltage application unit in a case when the liquid and the mist that are ejected from the nozzles are charged to have the same polarity as the driving signal.

Further, it is preferable that the voltage application section apply a voltage with a negative polarity to the voltage application unit.

According to such a configuration, it is possible to collect the mist at the voltage application unit in a case when the mist is charged with a positive polarity due to the Lenard effect.

According to each configuration described above, it is preferable that a configuration in which the voltage application unit is placed in a state of surrounding the liquid ejecting head be adopted.

According to such a configuration, it is possible to collect mist in the surroundings of the liquid ejecting head, and the adherence of mist to constituent parts within the apparatus can be reliably suppressed.

Furthermore, it is preferable that a configuration in which a movement section that moves the liquid ejecting head relatively with respect to the landing target is included, and the voltage application unit is placed along the movement range of the liquid ejecting head be adopted.

According to such a configuration, even in a case when the mist scatters along the movement range of the liquid ejecting head due to the airflow that is generated along with the movement of the liquid ejecting head, it is possible to reliably collect the mist.

Further, according to each configuration described above, it is preferable that a configuration in which the liquid ejecting head includes an opposing electrode unit on at least a portion of the position that opposes the voltage application unit and an electric field is formed between the opposing electrode unit and the voltage application unit be adopted.

According to such a configuration, whether the mist is charged to have a positive polarity or a negative polarity, the mist is collected by either one of the voltage application unit and the opposing electrode unit.

Further, it is preferable that a configuration in which the liquid ejecting head includes a second voltage application section that applies a voltage to the opposing electrode unit be adopted.

### BRIEF DESCRIPTION OF THE DRAWINGS

The invention will be described with reference to the accompanying drawings, wherein like numbers reference like elements.

FIGS. 1A and 1B are views that describe the configuration of a printer, FIG. 1A is a plan view, and FIG. 1B is a cross-sectional view taken along line IB-IB.

FIG. 2 is a cross-sectional view of the principal portions of a recording head.

FIG. 3 is a cross-sectional view that describes the configuration of a piezoelectric vibrator.

FIG. 4 is a block diagram that describes the electrical configuration of the recording head.

FIG. 5 is a waveform diagram that describes the configuration of an ejection driving pulse and a microvibration driving pulse.

FIGS. 6A and 6B are views that describe the configuration of a printer according to a second embodiment, FIG. 6A is a plan view, and FIG. 6B is a cross-sectional view taken along line VIB-VIB.

FIGS. 7A and 7B are views that describe the configuration of a printer according to a third embodiment, FIG. 7A is a plan view, and FIG. 7B is a cross-sectional view taken along line VIIB-VIIB.

FIGS. 8A and 8B are views that describe the configuration of a printer according to a fourth embodiment, FIG. 8A is a plan view, and FIG. 8B is a cross-sectional view taken along line VIIIB-VIIIB.

FIGS. 9A and 9B are schematic diagrams that describe the state of charging ink that is ejected from a nozzle according to a configuration in which an electric field is formed between the nozzle and a support member.

FIG. 10 is a schematic diagram that describes the state of charging ink that is ejected from a nozzle according to a configuration in which an electric field is not formed between the nozzle and the support member.

### DESCRIPTION OF EXEMPLARY EMBODIMENTS

Embodiments of the invention will be described below with reference to the attached drawings. Here, in the embodiments described below, while there are various limitations as preferable specific examples of the invention, the scope of the invention is not limited to such embodiments unless there is particular description to limit the invention in the description below. Further, an ink jet recording apparatus 1 (hereinafter, printer) will be described as an example of the liquid ejecting apparatus of the invention.

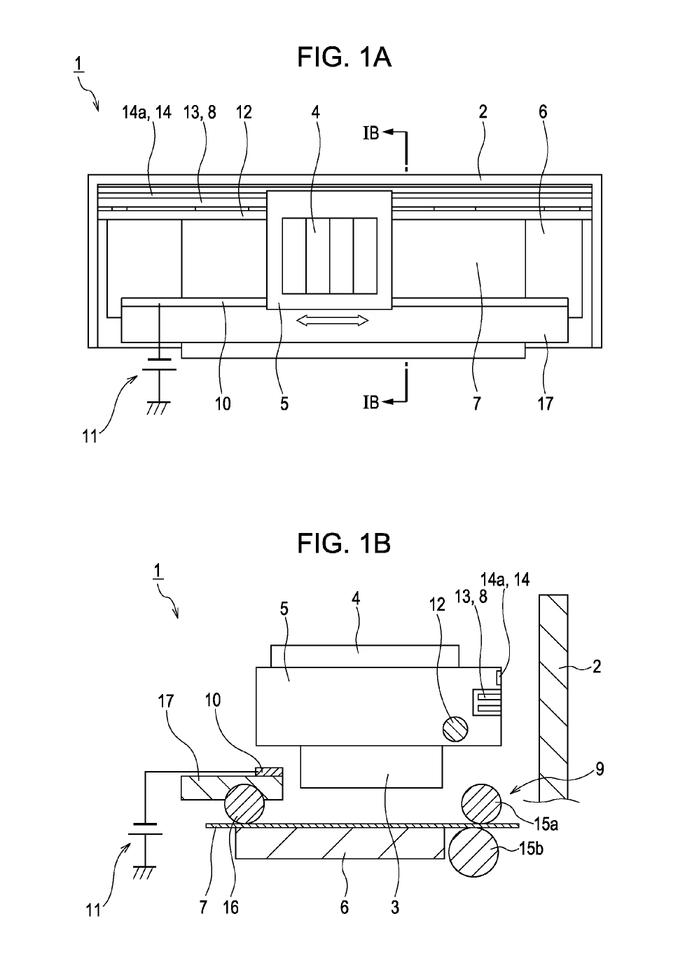

FIG. 1A is a plan view that illustrates the configuration of the printer 1, and FIG. 1B is a cross-sectional view of the line IB-IB. As well as a recording head 3 that is a type of liquid ejecting head being attached to the inside of a housing 2, the printer 1 includes a carriage 5 to which an ink cartridge 4 that is a type of liquid supply source is attached to be detachable, a platen 6 that is placed to leave a gap with the lower face (nozzle formation face) of the recording head 3 below the recording head 3 during a recording operation (ejection operation), a carriage moment mechanism 8 that moves the carriage 5 in the paper width direction of recording paper 7 (recording medium and a type of landing target), that is, the main scanning direction to be reciprocal, a transport mechanism 9 that transports the recording paper 7 in a sub scanning direction that intersects the main scanning direction, a voltage application unit 10 that is placed at a position that does not interfere with the recording head 3, and a voltage generation unit 11 (corresponds to a voltage application section in the invention) that applies a voltage to the voltage application unit 10.

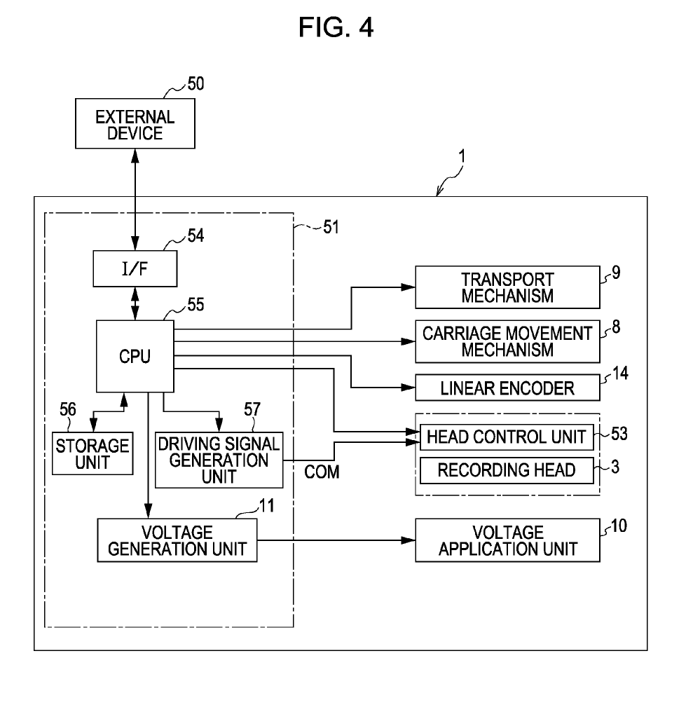

The carriage 5 is attached to a guide rod 12 that is bridged in the main scanning direction in an axially supported state, and is configured to move in the main scanning direction along the guide rod 12 by the operation of the carriage movement mechanism 8. The carriage movement mechanism 8 of the embodiment is configured by a carriage motor (not shown), a driving belt 13, and the like. Specifically, a driving pulley (not shown) is connected to the distal end portion of the driving axis of the carriage motor, which is configured to rotate according to the driving of the carriage motor. Further, an idling pulley (not shown) is provided at a position on the opposite side to the driving pulley in the main scanning direction. Further, the driving belt 13 that is an endless belt is stretched over the pulleys, and a portion of the driving belt 13 is connected to the carriage 5. Therefore, if the carriage motor is driven, the driving belt 13 moves, and the carriage 5 moves in the main scanning direction in response. Further, the position of the carriage 5 in the main scanning direction is detected by a linear encoder 14. The linear encoder 14 is configured by a linear scale 14a that is stretched in the main scanning direction and a sensor (not shown) that is provided on the carriage 5, and the detection signal thereof, that is, an encoder pulse EP (type of positional information) according to the scanning position of the recording head 3 is transmitted to a printer controller 51 (refer to FIG. 4).

The platen 6 is a plate-like member that is long in the main scanning direction, and is grounded (earthed) in the present embodiment. The transport mechanism 9 is included in front and behind the platen 6 in the sub scanning direction. The transport mechanism 9 supplies the recording paper 7 to the platen 6. In detail, the transport mechanism 9 includes a paper supply roller 15 that is positioned behind the platen 6 (upstream side in the transport direction of the recording paper 7), and at the front end portion of the platen 6 (downstream side in the transport direction of the recording paper 7), includes a paper hold down roller 16 that interposes the recording paper 7 with the platen 6, and a paper hold down member 17 to which the paper hold down roller 16 is attached and that biases the paper hold down roller 16 to the platen 6 side. The paper supply roller 15 is configured by a pair of upper and lower rollers 15a and 15b that are rotatable synchronized in opposite directions to each other in a state of interposing the recording paper 7 that is supplied from a paper supply unit (not shown). The paper supply roller 15 is driven by motive power from a paper supply motor (not shown), and is configured to supply the recording paper 7 to the platen 6 side after correcting the tilt with respect to the transport direction of the recording paper 7 and the position deviation in a direction that is orthogonal to the transport direction in cooperation with a skew correction roller (not shown). The paper hold down member 17 is a long plate-like member, and is attached in a state of being biased to the recording paper 7 side (platen 6 side) due to a biasing member such as a spring or due to its own weight while providing a gap with the recording head 3 to avoid interfering with the recording head 3. A plurality of paper hold down rollers 16 are lined up along the main scanning direction with equal intervals on the platen 6 side of the paper hold down member 17. The paper hold down rollers 16 are configured to be rotatable in a state of abutting the surface of the recording paper 7. Furthermore, the voltage application unit 10 is placed on the upper face (face on the opposite side to the platen 6) of the paper hold down member 17. Here, the upper face of the paper hold down member 17 of the present embodiment is positioned above the nozzle formation face described later (opposite side to the recording paper 7 side (platen 6 side)).

The voltage application unit 10 is placed along the movement range of the recording head 3 at a position that does not interfere with the recording head 3 and at a position outside the nozzle formation face described later on the opposite side to the recording paper 7 side (platen 6 side) (position that is on the opposite to the recording paper 7 with respect to the nozzle formation side and that is outside a region that opposes the nozzle formation face). Specifically, the voltage application unit 10 is formed by a long metallic thin plate or the like, and is placed across the length of the paper hold down member 17 on the back end portion (recording head 3 side) of the upper face of the paper hold down member 17. Further, the voltage generation unit 11 that applies a voltage to the voltage application unit 10 is connected to the voltage application unit 10, and a predetermined voltage is applied. Here, the voltage that is applied to the voltage application unit 10 will be described later.

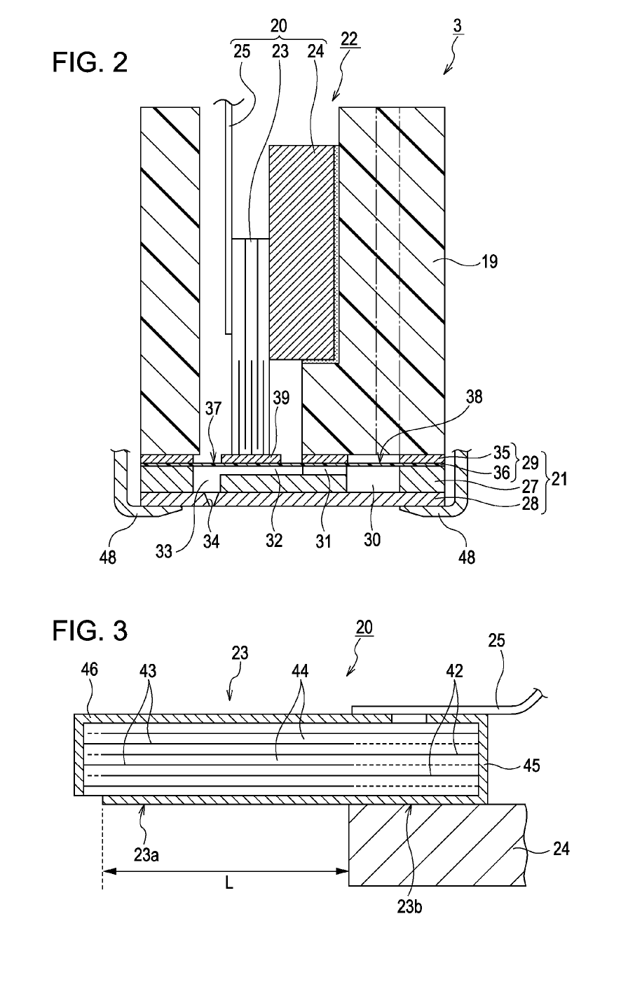

As illustrated in FIG. 2, the recording head 3 includes a case 19, a vibrator unit 20 that is stored within the case 19, and a flow path unit 21 that is joined to the bottom face (distal end face) of the case 19, a cover member 48, and the like. The case 19 described above is made of an epoxy resin, for example, and a storage space portion 22 for storing the vibrator unit 20 is formed therein. The vibrator unit 20 includes a piezoelectric vibrator 23 that function as a type of pressure generator, a fixing plate 24 with which the piezoelectric vibrator 23 is joined, and a flexible cable 25 that supplies a driving signal to the piezoelectric vibrator 23.

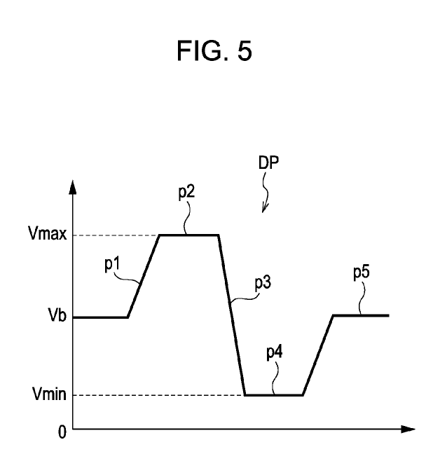

FIG. 3 is a cross-sectional view in the element longitudinal direction which describes the configuration of the vibrator unit 20. As illustrated in the drawing, the piezoelectric vibrator 23 is a laminated type piezoelectric vibrator 23 in which common internal electrodes 42 and individual internal electrodes 43 are laminated alternately with a piezoelectric body 44 in between. Here, the common internal electrodes 42 are electrodes that are common to all piezoelectric vibrators 23, and are set to have a ground potential. Further, the individual internal electrodes 43 are electrodes with which the potential fluctuates according to an ejection driving pulse DP of the driving signal that is applied (refer to FIG. 5). Furthermore, in the present embodiment, a portion of the piezoelectric vibrator 23 from the vibrator distal end to approximately half or approximately two thirds in the vibrator longitudinal direction (direction that is orthogonal to the laminating direction) is a free end portion 23a. Further, the remaining portion of the piezoelectric vibrator 23, that is, the portion from the base end of the free end portion 23a to the vibrator base end is a base end portion 23b.

An active region (overlap portion) L in which the common internal electrode 42 and the individual internal electrodes 43 overlap is formed on the free end portion 23a. If a potential difference is conferred on the internal electrodes, the piezoelectric body 44 in the active region L operates and deforms, and the free end portion 23a is displaced and expands and contracts in the vibrator longitudinal direction. Furthermore, the base ends of the common internal electrodes 42 are connected to a common external electrode 45 at the base end face portion of the piezoelectric vibrator 23. On the other hand, the distal ends of the individual internal electrodes 43 are connected to individual external electrodes 46 at the distal end face portion of the piezoelectric vibrator 23. Here, the distal ends of the common internal electrodes 42 are positioned slightly in front (base end face side) of the distal end face portion of the piezoelectric vibrator 23, and the base ends of the individual internal electrodes 43 are positioned at an interface between the free end portion 23a and the base end portion 23b.

The individual external electrodes 46 are electrodes that are formed to be in series with the distal end face portion of the piezoelectric vibrator 23 and a wiring connection face (face to the upper side of FIG. 3) that is one side face of the piezoelectric vibrator 23 in the lamination direction, and make the wiring pattern of a flexible cable 25 as a wiring member and each individual internal electrodes 43 conductive. Furthermore, the portions of the individual external electrodes 46 on the wiring connection face side are formed continuously from the base end portion 23b toward the distal end side. The common external electrode 45 is an electrode that is formed to be in series with the base end face portion of the piezoelectric vibrator 23, the wiring connection face described above, and a fixed plate attachment face (face on the lower side of FIG. 3) that is another side face of the piezoelectric vibrator 23 in the laminating direction, and makes the wiring pattern of the flexible cable 25 and each common internal electrode 42 conductive. Further, the portion of the common external electrode 45 to the wiring connection face side is formed continuously from slightly in front of the end portion of the individual external electrodes 46 toward the base end face portion side, and the portion on the fixed portion attachment face side is formed continuously from a position that is slightly in front of the distal end face portion of the piezoelectric vibrator 23 toward the base end side.

The base end portion 23b described above is a non-operated portion that does not expand or contract even with the piezoelectric body 44 of the active region L is operated. The flexible cable 25 is placed on the wiring connection face side of the base end portion 23b, and the individual external electrodes 46, the common external electrode 45, and the flexible cable 25 are electrically connected on the base end portion 23b. Furthermore, a driving signal is applied to each individual external electrode 46 through the flexible cable 25.

The flow path unit 21 is configured by respectively joining a nozzle plate 28 to one face of a flow path formation substrate 27 and a vibration plate 29 to the other face of the flow path formation substrate 27. A reservoir 30 (common liquid chamber), an ink supply opening 31, a pressure chamber 32, a nozzle connection opening 33, and nozzles 34 are provided on the flow path unit 21. Furthermore, the series of ink flow path from the ink supply opening 31 to the nozzles 34 through the pressure chamber 32 and the nozzle connection opening 33 is formed to correspond with each nozzle 34.

The nozzle plate 28 described above is a thin plate made of metal such as stainless steel in which a plurality of nozzles 34 are drilled in a row pattern with a pitch that corresponds to the dot formation density (for example, 180 dpi). A plurality of nozzle rows (nozzle groups) are provided on the nozzle plate 28 by the nozzles 34 being arranged in rows, and one nozzle row is configured, for example, by 180 nozzles 34. The face of the nozzle plate 28 on which ink is ejected from the nozzles 34 corresponds to the nozzle formation face of the invention.

The vibration plate 29 described above has a duplex structure in which an elastic film 36 is laminated on the surface of a support plate 35. According to the present embodiment, the vibration plate 29 is created by the support plate 35 being a stainless plate that is a type of metallic plate, and using a composite plate material in which a resin film is laminated as the elastic film 36 on the surface of the support plate 35. A diaphragm unit 37 that changes the volume of the pressure chamber 32 is provided on the vibration plate 29. Further, a compliance unit 38 that seals a portion of the reservoir 30 is provided on the vibration plate 29.

The diaphragm unit 37 described above is created by partially removing the support plate 35 by an etching process or the like. That is, the diaphragm unit 37 is composed of an island portion 39 to which the distal end face of the free end portion 23a of the piezoelectric vibrator 23 is joined and a thin-walled elastic portion that surrounds the island portion 39. Similarly to the diaphragm unit 37, the compliance unit 38 described above is created by removing the support plate 35 in a region that opposes the opening face of the reservoir 30 by an etching process or the like, and functions as a damper that absorbs the pressure fluctuation of the liquid that is stored in the reservoir 30.

Furthermore, since the distal end face of the piezoelectric vibrator 23 is joined with the island portion 39 described above, the volume of the pressure chamber 32 can be made to fluctuate by expanding and contracting the free end portion 23a of the piezoelectric vibrator 23. A pressure fluctuation in the ink within the pressure chamber 32 is caused along with such a volume fluctuation. Furthermore, the recording head 3 ejects ink from the nozzles 34 using such a pressure fluctuation.

The cover member 48 is a member that protects the side face of the flow path unit 21 and the side face of the case 19, and is made of a plate material with conductivity such as stainless steel. A portion of the cover member 48 according to the present embodiment abuts a rim portion of the nozzle formation face in a state of exposing the nozzles 34 of the nozzle plate 28, and is electrically conductive with the nozzle plate 28. The cover member 48 is grounded, and by being conductive by being in contact with the nozzle plate 28, damage to the driving IC or the like or charging of the nozzle plate 28 due to static electricity that is generated by the recording paper 7 or the like being transmitted through the nozzle plate 28, for example, is prevented.

Next, the electrical configuration of the printer 1 will be described. FIG. 4 is a block diagram that describes the electrical configuration of the printer 1. An external device 50 is an electronic apparatus that handles images such as, for example, a computer or a digital camera. The external device 50 is connected to a printer controller 51 of the printer 1 to be communicable, and transmits the print data according to such images or the like to the printer 1 so that images and text are printer by the printer 1 on a recording medium such as the recording paper 7.

The printer 1 according to the present embodiment includes the transport mechanism 9, the carriage movement mechanism 8, the linear encoder 14, the recording head 3, the voltage application unit 10, and the printer controller 51.

The printer controller 51 is a control unit for performing control of each portion of the printer 1, and includes an interface (I/F) unit 54, a CPU 55, a storage unit 56, a driving signal generation unit 57, and the voltage generation unit 11. The interface unit 54 performs transceiving of data with the printer 1 such as receiving print data and print orders that are transmitted from the external device 50 to the printer 1, transmitting status information of the printer 1 to the external device 50, and the like. The CPU 55 is a computation processing device for performing control of the entirety of the printer 1. The storage unit 56 is an element that stores programs of the CPU 55 and data that is used for various controls, and includes a ROM, a RAM, and an NVRAM (non-volatile storage element). The CPU 55 controls each unit according to a program that is stored in the storage unit 56.

The CPU 55 functions as timing pulse generator that generates a timing pulse PTS from the encoder pulse EP that is output from the linear encoder 14. Furthermore, the CPU 55 controls transfer of the print data, generation of a driving signal COM by the driving signal generation unit 57, and the like by synchronizing with the timing pulse PTS. Further, the CPU 55 outputs a timing signal such as a latch signal LAT to a head control unit 53 of the recording head 3 based on the timing pulse PTS. The head control unit 53 controls the ejection driving pulse DP (refer to FIG. 5) of the driving signal COM with respect to the piezoelectric vibrator 23 of the print head 3 and the like based on a head control signal (print data and a timing signal) from the printer controller 51.

The driving signal generation unit 57 generates an analog voltage signal based on waveform data that relates to the waveform of the driving signal. Further, the driving signal generation unit 57 generates the driving signal COM by amplifying the voltage signal described above. The driving signal COM is applied to the piezoelectric vibrator 23 that is a pressure generator of the recording head 3 during the printing process (recording process or ejection process) on the recording medium, and is a series of signals that include at least one ejection driving pulse DP illustrated in FIG. 5, for example. Here, the ejection driving pulse DP performs a predetermined operation on the piezoelectric vibrator 23 so that ink in droplet-form is ejected from the nozzles 34 of the recording head 3.

FIG. 5 is a waveform diagram that illustrates an example of the ejection driving pulse DP that is included in the driving signal COM. Here, in FIG. 5, the vertical axis is the potential and the horizontal axis is time. Further, as illustrated in FIG. 5, the ejection driving pulse DP of the present embodiment has a positive polarity on average. The ejection driving pulse DP includes an expansion element p1 that expands the pressure chamber 32 by the potential changing to the plus side from a standard potential (intermediate potential) Vb to a maximum potential (maximum voltage) Vmax, an expansion maintenance element p2 that maintains the maximum potential Vmax for a fixed amount of time, a contraction element p3 that rapidly contracts the pressure chamber 32 by the potential changing to the minus side from the maximum potential Vmax to a minimum potential (minimum voltage) Vmin, a contraction maintenance (vibration suppression hold) element p4 that maintains the minimum potential Vmin for a fixed amount of time, and a return element p5 in which the potential returns from the minimum potential Vmin to the standard potential Vb.

The piezoelectric vibrator 23 operates as below when the ejection driving pulse DP is applied. First, the piezoelectric vibrator 23 is contracted by the expansion element p1, and the pressure chamber 32 accordingly expands from a standard volume that corresponds to the standard potential Vb to a maximum volume that corresponds to the maximum potential Vmax. In so doing, the meniscuses that are exposed to the nozzles 34 are drawn to the pressure chamber 32 side. The expansion state of the pressure chamber 32 is maintained constant over the application period of the expansion maintenance element p2. When the contraction element p3 is applied to the piezoelectric vibrator 23 following the expansion maintenance element p2, the piezoelectric vibrator 23 elongates, and in so doing, the pressure chamber 32 rapidly contracts from the maximum volume described above to a minimum volume that corresponds to the minimum potential Vmin. The ink within the pressure chamber 32 is pressurized by the rapid contraction of the pressure chamber 32, and several p1 to several tens of p1 of ink is thus ejected from the nozzles 34. The contraction state of the pressure chamber 32 is maintained for a short period of time over the application period of the contraction maintenance element p4, and thereafter, the vibration suppression element p5 is applied to the piezoelectric vibrator 23, and the pressure chamber 32 returns from a volume that corresponds to the minimum potential Vmin to the standard volume that corresponds to the standard potential Vb.

The voltage generation unit 11 functions as a power source that generates a voltage that is applied to the voltage application unit 10. Furthermore, the voltage generation unit 11 of the present embodiment is characterized by applying a negative voltage to the voltage application unit 10. Therefore, the voltage application unit 10 forms electric fields between the constituent parts within the printer 1 such as, for example, the casing 2, the recording head 3, the motor, the driving belt 13, and the linear scale 14a. In particular, excluding a case when both have the same potential, a strong electric field in comparison to the other constituent parts is formed between the voltage application unit 10 and the portion of the recording head 3 that opposes the voltage application unit 10. Here, although the constituent parts within the printer 1 may conceivably be negatively charged, the voltage of the voltage generation unit 11 is set to be lower than such charged voltages.

Here, the driving signal (ejection driving pulse DP) of the present embodiment has a positive polarity as described above, and since a negative charge and a positive charge are respectively inducted at the ink within the pressure chamber 32 in the vicinity of the piezoelectric vibrator 23 and the ink in the vicinity of the nozzles 34 due to electrostatic induction during a recording operation, the ink that is ejected from the nozzles 34 is positively charged. In addition, the positive charge of the ink in flight toward the recording paper 7 is strengthened even further by the Lenard effect. Accordingly, the satellite droplets and even smaller mist that are generated by the ink separated during flight are positively charged. Such satellite droplets and mist (hereinafter, mist and the like) are then inducted toward the voltage generation unit 11 with a negative polarity.

In such a manner, by applying a voltage with the opposite polarity (negative in the present embodiment) to the mist and the like that are generated along with the ejection of the liquid from the nozzles 34 to the voltage application unit 10, the mist and the like are able to be collected at the voltage application unit 10, and the adherence of the mist and the like on the constituent parts within the printer 1 (for example, the motor, the driving belt 13, the linear scale 14a, and the like) is decreased. As a result, breakdowns due to the adherence of the mist and the like are suppressed, and the durability and reliability of the printer 1 improve. Further, since the voltage application unit 10 is placed at a position that is on the opposite side to the recording paper 7 side with respect to the nozzle formation face and that is outside a region that opposes the nozzle formation face, the generation of an electric field (wraparound electric field) between the voltage application unit 10 and the nozzle formation face can be prevented, and the flight of the liquid (main droplet) becoming unstable due to the influence of such an electric field can be prevented. Furthermore, since a configuration in which the voltage application unit 10 is placed along the movement range of the recording head 3 has been adopted, even in a case when the mist and the like are scattered along the movement range of the recording head 3 by the airflow that is generated along with the movement of the recording head 3, the mist and the like can be more reliably collected. Further, while the mist and the like tend to fly from the upstream side to the downstream side of the transport direction along with the airflow during the transportation of the recording paper 7, since the voltage application unit 10 is included on the paper hold down member 17 to the downstream side in the transport direction, the mist and the like can be collected even more reliably.

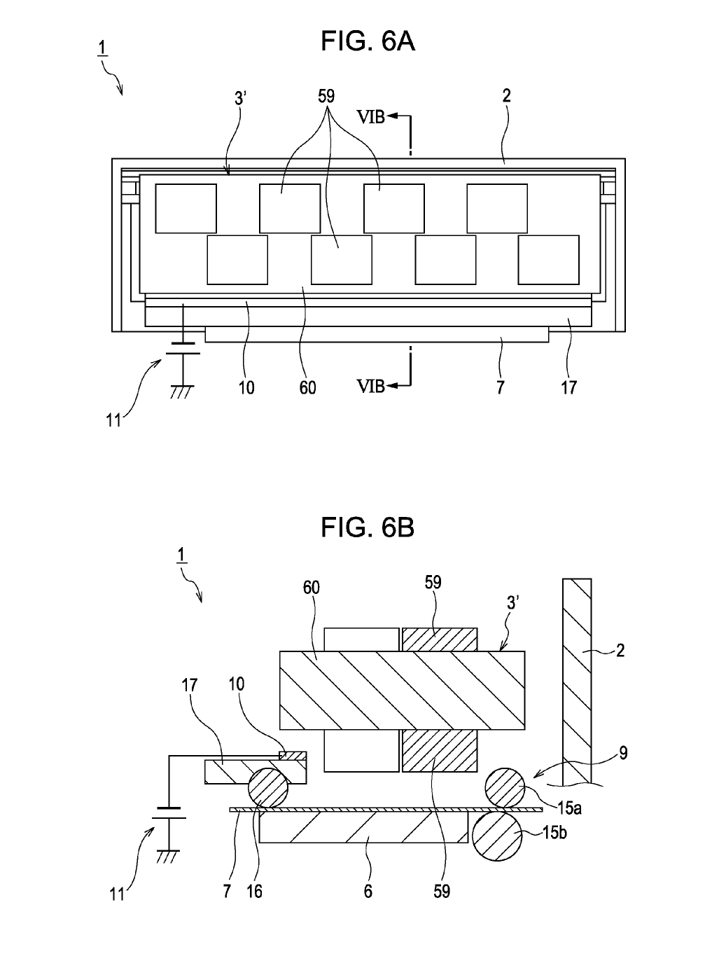

Incidentally, the invention is not limited to the first embodiment described above. For example, printers of second to fourth embodiments are illustrated in FIGS. 6A and 6B to FIGS. 8A and 8B as other embodiments.

A recording head 3′ of the second embodiment illustrated in FIGS. 6A and 6B is a type of so-called line head-type liquid ejecting head in which a plurality of unit recording heads 59 are included on a holder 60. The position of the recording head 3′ during the printing process is fixed. The recording head 3′ arranges a plurality of unit recording heads 59 in the paper width direction across a length that is equal to or greater than the paper width of the recording paper 7, and arranges adjacent unit recording heads 59 to be alternately deviated in a direction that is orthogonal to the paper width direction. Therefore, with the present embodiment, the carriage 5, the carriage movement mechanism 8, the linear encoder 14, and the like are not included, nor are the encoder pulse EP and the like generated. Further, an ink cartridge 4 is attached to the upper face of the holder 60 to be detachable to correspond to each unit recording head 59. Furthermore, the paper hold down member 17 is made to have approximately the same length as the length of the recording head 3′ in the arrangement direction (paper width direction of the recording paper 7) of the unit recording heads 59. Further, similarly to the first embodiment, the voltage application unit 10 is placed at a position that does not interfere with the recording head 3′ that is on the opposite side to the recording paper 7 side (platen 6 side) with respect to the nozzle formation face and that is outside a region that opposes the nozzle formation face. Specifically, the voltage application unit 10 is placed at the back end portion (recording head 3′ side) of the upper face of the paper hold down member 17 across the length of the paper hold down member 17. Here, since the configuration of the unit recording head 59 is the same as the configuration of the recording head 3 of the first embodiment, description thereof will be omitted. Further, other configurations are the same as the printer 1 of the first embodiment, and since the electrical configuration of the printer 1 is the same other than the absence of the carriage movement mechanism 8 and the linear encoder 14, description thereof will be omitted.

In the case of the second embodiment, similarly to the first embodiment, it is also possible to collect the mist and the like at the voltage application unit 10 by applying a voltage with the opposite polarity to the mist and the like that are generated by the ejection of the liquid from the nozzles 34 to the voltage application unit 10, and the adherence of the mist and the like to the constituent parts within the printer 1 is decreased. As a result, breakdowns due to the adherence of mist and the like are suppressed, and the durability and reliability of the printer 1 improve. Further, since the voltage application unit 10 is placed at a position on the opposite side to the recording paper 7 side with respect to the nozzle formation face and that is outside a region that opposes the nozzle formation face, the generation of an electric field (wraparound electric field) between the voltage application unit 10 and the nozzle formation face can be prevented, and the flight of the liquid (main droplet) becoming unstable due to the influence of the electric field can be prevented. Furthermore, while the mist and the like tend to fly from the upstream side to the downstream side of the transport direction along with the airflow during the transport of the recording paper 7, since the voltage application unit 10 is included on the paper hold down member 17 on the downstream side of the transport direction, the mist and the like can be collected even more reliably.

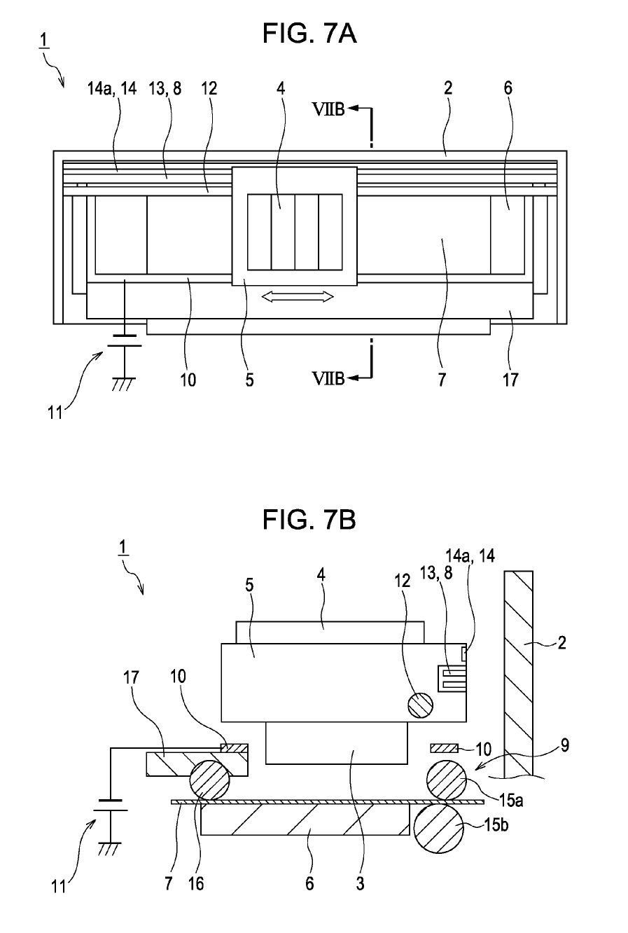

A printer 1 of the third embodiment illustrated in FIGS. 7A and 7B differs from the first embodiment in that the voltage application unit 10 is placed in a state of surrounding the surroundings (movement range of the recording head 3) of the recording head 3. The voltage application unit 10 of the present embodiment is placed at a position that is on the opposite side to the recording paper 7 side with respect to the nozzle formation face and that is outside of a region that opposes the nozzle formation face in a state of surrounding the outer circumference of the movement range of the recording head 3 in a rectangular frame shape so as not to interfere with the recording head 3. Specifically, similarly to the first embodiment, one side of the voltage application unit 10 is placed on the back end portion (recording head 3 side) of the upper face of the paper hold down member 17 across the length of the paper hold down member 17. Further, another side on the opposite side (upstream side) to such a side with the recording head 3 therebetween is placed in a state of being supported by a support member (not shown) above the paper supply roller 15. Furthermore, both end portions of such sides are connected by a side that is parallel in the sub scanning direction. Here, since other configurations are the same as the printer 1 of the first embodiment, description will be omitted.

In the case of the third embodiment, similarly to the first embodiment, it is also possible to collect the mist and the like at the voltage application unit 10 by applying a voltage with the opposite polarity to the mist and the like that are generated by the ejection of the liquid from the nozzles 34 to the voltage application unit 10, and the adherence of the mist and the like to the constituent parts within the printer 1 is decreased. As a result, breakdowns due to the adherence of mist and the like are suppressed, and the durability and reliability of the printer 1 improve. Further, since the voltage application unit 10 is placed at a position on the opposite side to the recording paper 7 side with respect to the nozzle formation face and that is outside a region that opposes the nozzle formation face, the generation of an electric field (wraparound electric field) between the voltage application unit 10 and the nozzle formation face can be prevented, and the flight of the liquid (main droplet) becoming unstable due to the influence of the electric field can be prevented. Furthermore, since a configuration in which the voltage application unit 10 is placed along the movement range of the recording head 3 has been adopted, even in a case when the mist and the like are scattered along the movement range of the recording head 3 by the airflow that is generated along with the movement of the recording head 3, the mist and the like can be reliably collected. Further, since the voltage application unit 10 is placed in a state of surrounding the surroundings of the recording head 3, the mist and the like can be more reliably collected in the surroundings of the recording head 3, and the adherence of the mist and the like on the constituent parts within the apparatus can be reliably suppressed.

Here, while a driving signal with a positive polarity were used in the first to third embodiments described above, a driving signal with a negative polarity may also be used. In such a case, the ink that is ejected from the nozzles 34 is negatively charged by electrostatic induction due to the voltage of the piezoelectric vibrator 23. On the other hand, as described above, the positive charge of ink in flight is strengthened by the Lenard effect. While the charge polarity of the mist and the like is determined by such trade-offs, the strength of any influence is determined by a variety of factors such as the structure of the printer 1 or the waveform of the driving signal, and is not unconditional. However, in any case, the voltage of the voltage application unit 10 may be set to have the opposite polarity to the charge polarity of the mist and the like. In such a case, for example, in a case when the electrostatic induction due to the voltage of the piezoelectric vibrator 23 is dominant, since the mist and the like are negatively charged, the voltage generation unit 11 may apply a voltage with the opposite polarity (positive) to the polarity of the driving signal (negative) to the voltage application unit 10. On the other hand, in a case when the Lenard effect is dominant, since the mist and the like are positive charged, the voltage generation unit 11 may apply a negative voltage to the voltage application unit 10. Furthermore, in either case, it is possible to collect the mist and the like at the voltage application unit 10.

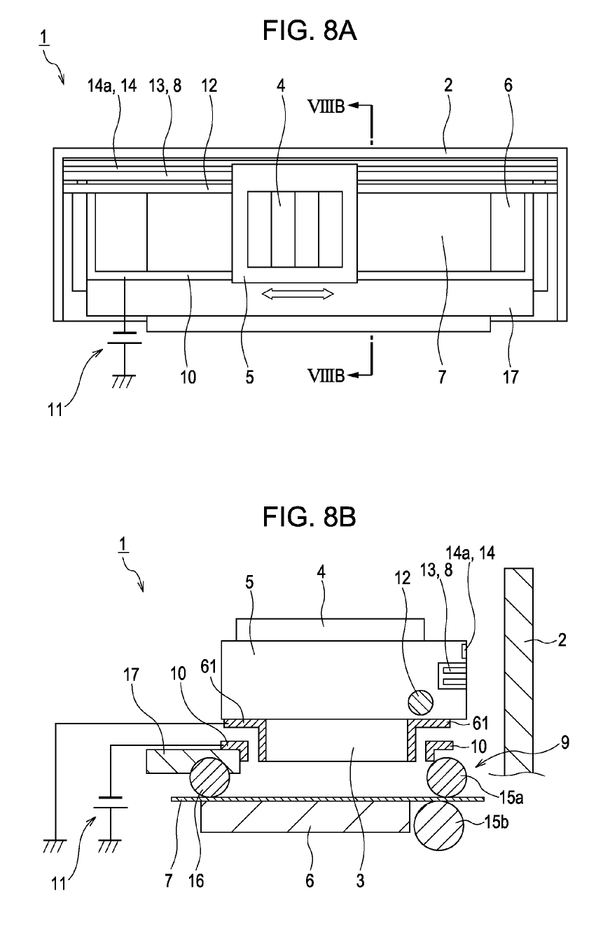

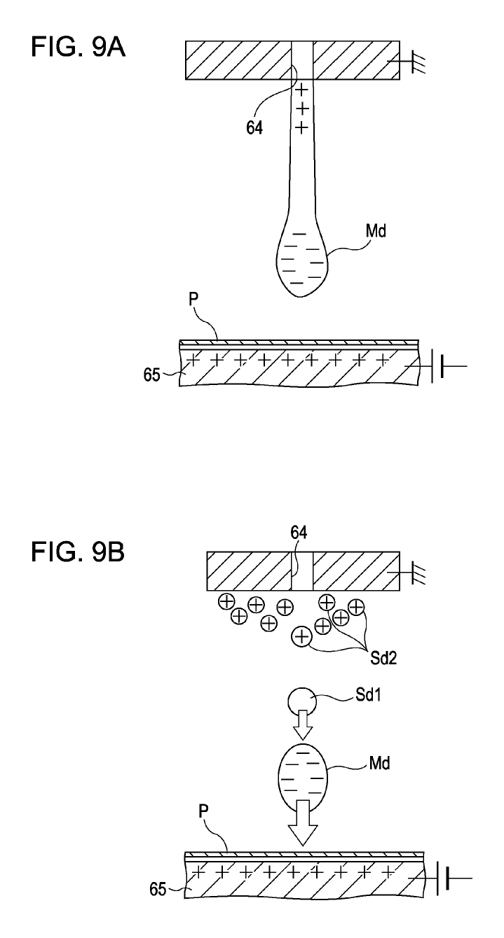

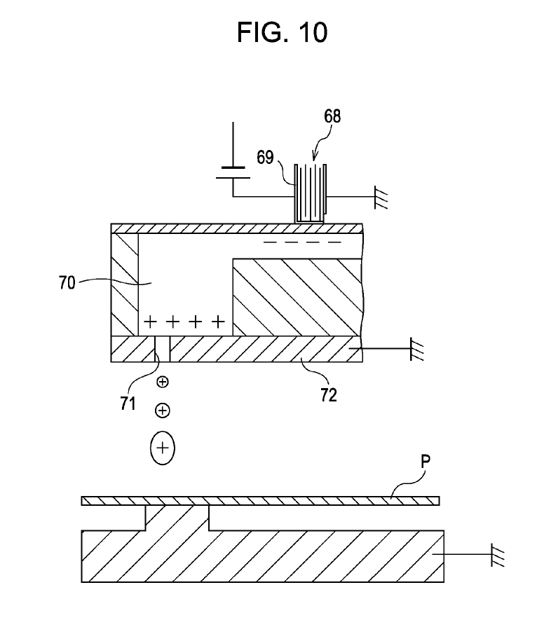

With the printer 1 of the fourth embodiment illustrated in FIGS. 8A and 8B, there is no need to verify the charge polarity of the mist and the like even with the case described above. That is, the fourth embodiment differs from the first to third embodiments described above in being configured so that an opposing electrode unit 61 is provided at a position that opposes the voltage application unit 10, and the mist and the like can be collected regardless of the charge polarity by an electric field between the voltage application unit 10 and the opposing electrode unit 61. Specifically, similarly to the third embodiment, the voltage application unit 10 of the present embodiment is placed at a position that is on the opposite side to the recording paper 7 side with respect to the nozzle formation face and that is outside of a region that opposes the nozzle formation face in a state of surrounding the outer circumference of the movement range of the recording head 3 in a rectangular frame shape so as not to interfere with the recording head 3. Further, in the present embodiment, the edge of the voltage application unit 10 on the inside which is formed in a frame shape is bent downward and extends in the direction of the platen 6. In more detail, similarly to the third embodiment, the upper face of one side (side further to the downstream side than the recording head 3) of the voltage application unit 10 is placed on the back end portion (recording head 3 side) of the upper face of the paper hold down member 17 across the length of the paper hold down member 17, and the back end side is bent downward along a side face of the paper hold down member 17 on the back end side. Further, another side on the opposite side (upstream side) to such a side with the recording head 3 therebetween bends the front end side (recording head 3 side) thereof downward toward the paper supply roller 15 side above the paper supply roller 15. Here, the lower end portion of the portion of the voltage application unit 10 which is bent downward is positioned above the nozzle formation face. Further, the opposing electrode unit 61 is included on at least a portion of the recording head 3 at a position that opposes the voltage application unit 10. The opposing electrode unit 61 of the present embodiment encloses the side face of the recording head 3 (side face of the case 19 or the cover member 48) and causes such a portion to oppose the vertical portion of the voltage application unit 10. Further, the opposing electrode unit 61 also extends to the lower face of a portion (flange portion) that extends toward the outside with respect to the side face at the upper end portion of the recording head 3, and causes such a portion to oppose the upper face portion (horizontal portion) of the voltage application unit 10. Furthermore, in the present embodiment, the opposing electrode unit 61 is grounded (earthed). Here, since other configurations are the same as the printer 1 of the first embodiment, description will be omitted.

Similarly to the first embodiment, since a negative voltage is applied to the voltage application unit 10 and the opposing electrode unit 61 is grounded, an electric field is formed between the opposing electrode unit 61 and the voltage application unit 10. In the present embodiment, since the mist and the like are positively charged, it is possible to collect the mist and the like at the voltage application unit 10. Here, the recording head 3 of the present embodiment is movable, and while a portion of the voltage application unit 10 does not oppose the opposing electrode unit 61, since electric fields are formed between the constituent parts within the printer 1 such as the casing 2, the motor, the driving belt 13, and the linear scale 14a, the mist and the like can be collected even at such a portion. Incidentally, according to the fourth embodiment, collection is possible even in a case when the mist and the like are negatively charged. For example, there is a possibility that the mist and the like are negatively charged due to electrostatic induction by an electric field entering from the outside between the nozzle formation face and the platen 6. Even in such a case, since an electric field is formed between the opposing electrode unit 61 and the voltage application unit 10, it is possible to collect the mist and the like at the opposing electrode unit 61. Here, although the opposing electrode unit 61 is grounded (earthed) in the present embodiment, a second voltage application unit (second voltage application section) that applies a voltage to the opposing electrode unit 61 may be included. Essentially, a configuration in which an electric field is formed between the opposing electrode unit 61 and the voltage application unit 10 is sufficient.

In such a manner, in the fourth embodiment, since the opposing electrode unit 61 is included and an electric field is formed between the opposing electrode unit 61 and the voltage application unit 10, the mist and the like can be collected at either one of the electrode application unit 10 and the opposing electrode unit 61 regardless of the charge polarity of the mist and the like.

Here, while the voltage application unit is provided separately from the paper hold down member in each of the embodiments described above, the paper hold down member itself may be the voltage application unit. Further, while the opposing electrode unit is provided separately from the recording head in the fourth embodiment, the cover member itself of the recording head may be the opposing electrode unit.

Further, without being limited to a printer, as long as an apparatus is a liquid ejecting apparatus with which control of the ejection of liquid is possible using pressure generators, the invention can be applied to various ink jet recording apparatuses such as a plotter, a facsimile apparatus, or a copier, and liquid ejecting apparatuses other than recording apparatuses such as, for example, a display manufacturing apparatus, an electrode manufacturing apparatus, or a chip manufacturing apparatus. Furthermore, with a display manufacturing apparatus, a solution of each color material of R (Red), G (Green), and B (Blue) is ejected from color material ejecting heads. Further, with an electrode manufacturing apparatus, a liquid electrode material is ejected from an electrode material ejecting head. With a chip manufacturing apparatus, a bioorganic solution is ejected from a bioorganic ejecting head.

What is claimed is:

1. A liquid ejecting apparatus comprising:
a liquid ejecting head that includes a nozzle formation face on which a nozzle that ejects a liquid is formed and a pressure generator that is driven by an application of a driving signal for causing a pressure fluctuation in the liquid within a pressure chamber that is connected to the nozzle, and that ejects the liquid from the nozzle to a landing target by a driving of the pressure generator;
a voltage application unit that is placed at a position that does not interfere with the liquid ejecting head, on an opposite side to the landing target with respect to the nozzle formation face, and at a position outside a region that opposes the nozzle formation face; and
a voltage application section that applies a voltage to the voltage application unit.

2. The liquid ejecting apparatus according to claim 1,
wherein the voltage application section applies a voltage with an opposite polarity to a polarity of the driving signal to the voltage application unit.

3. The liquid ejecting apparatus according to claim 1,
wherein the voltage application section applies a voltage with a negative polarity to the voltage application unit.

4. The liquid ejecting apparatus according to claim 1,
wherein the voltage application unit is placed in a state of surrounding the liquid ejecting head.

5. The liquid ejecting apparatus according to claim 1, further comprising:
a movement section that moves the liquid ejecting head relatively with respect to the landing target,
wherein the voltage application unit is placed along a movement range of the liquid ejecting head.

6. The liquid ejecting apparatus according to claim 1,
wherein the liquid ejecting head includes an opposing electrode unit on at least a portion of a position that opposes the electrode application unit, and
an electric field is formed between the opposing electrode unit and the voltage application unit.

7. The liquid ejecting apparatus according to claim 6,
wherein the liquid ejecting head includes a second voltage application section that applies a voltage to the opposing electrode unit.
